(19) United States
(12) Patent Application Publication
(10) Pub. No.: US 2014/0111431 A1
(43) Pub. Date: Apr. 24, 2014

(54) OPTIMIZING PHOTOS

(71) Applicant: Bradley Horowitz, Palo Alto, CA (US)

(72) Inventor: Bradley Horowitz, Palo Alto, CA (US)

(21) Appl. No.: 13/655,182

(22) Filed: Oct. 18, 2012

(51) Int. Cl. G06F 3/033

(52) U.S. Cl. 345/158

(57) ABSTRACT

Implementations generally relate to optimizing photos. In some implementations, a method includes collecting attention information associated with one or more objects. The method further includes generating an attention map based on the attention information. The method further includes allocating resources to the one or more objects in one or more photos based on the attention map.

### BACKGROUND

Digital cameras have made taking photos easy and convenient, and various applications have made sharing photos easy and convenient. For example, some applications enable a user to instantly upload photos to a social network system as photos are captured. Transmission and storage of photos is a growing issue, as the overall volume of photos increases. Image compression is used to reduce the amount of image data in order to more efficiently transmit and store photos.

### SUMMARY

Implementations generally relate to optimizing photos. In some implementations, a method includes collecting attention information associated with one or more objects. The method further includes generating an attention map based on the attention information. The method further includes allocating resources to the one or more objects in one or more photos based on the attention map.

With further regard to the method, in some implementations, the photos are captured using a device that is operable to track a gaze of a user. In some implementations, the attention map is also based on tracking a gaze of a user. In some implementations, the generating includes receiving gaze information; identifying the one or more objects; and associating the gaze information with each of the one or more objects. In some implementations, the generating includes receiving gaze information; identifying the one or more objects; associating the gaze information with each of the one or more objects; and determining an attention value for each of the one or more objects based on the gaze information. In some implementations, the resources include pixels allocated to each of the one or more objects in the one or more photos. In some implementations, the allocating includes allocating a predetermined pixel density to the one or more objects in the one or more photos based on the attention map. In some implementations, the allocating includes allocating a higher pixel density to objects that receive an attention value meeting a predetermined attention value criteria. In some implementations, the allocating includes allocating a higher pixel density to objects that receive an attention value meeting a predetermined attention value criteria such that those objects have a resolution in the one or more photos meeting a predetermined resolution criteria. In some implementations, the allocating includes allocating a lower pixel density to objects that receive an attention value meeting a predetermined attention value criteria.

In some implementations, a method includes collecting attention information associated with one or more objects, where the attention information is captured using a device that is operable to track a gaze of a user. The method further includes generating an attention map based on the attention information. In some implementations, the generating includes receiving gaze information; identifying the one or more objects; associating the gaze information with each of the one or more objects; and determining an attention value for each of the one or more objects based on the gaze information. The method further includes allocating resources to the one or more objects in one or more photos based on the attention map, where the resources include pixels allocated to each of the one or more objects in the photos In some implementations, the allocating includes allocating a higher pixel density to objects that receive an attention value meeting a first predetermined attention value criteria such that those objects have a resolution in the photos meeting a predetermined resolution criteria; and allocating a lower pixel density to objects that receive an attention value meeting a second predetermined attention value criteria.

In some implementations, a system includes one or more processors, and logic encoded in one or more tangible media for execution by the one or more processors. When executed, the logic is operable to perform operations including: collecting attention information associated with one or more objects; generating an attention map based on the attention information; and allocating resources to the one or more objects in one or more photos based on the attention map.

With further regard to the system, in some implementations, the photos are captured using a device that is operable to track a gaze of a user. In some implementations, the attention map is also based on tracking a gaze of a user. In some implementations, to generate the attention map, the logic when executed is further operable to perform operations including: receiving gaze information; identifying the one or more objects; and associating the gaze information with each of the one or more objects. In some implementations, to generate the attention map, the logic when executed is further operable to perform operations including: receiving gaze information; identifying the one or more objects; associating the gaze information with each of the one or more objects; and determining an attention value for each of the one or more objects based on the gaze information. In some implementations, the resources include pixels allocated to each of the one or more objects in the one or more photos. In some implementations, to allocate resources, the logic when executed is further operable to perform operations including allocating a predetermined pixel density to the one or more objects in the one or more photos based on the attention map. In some implementations, to allocate resources, the logic when executed is further operable to perform operations including allocating a higher pixel density to objects that receive an attention value meeting a predetermined attention value criteria. In some implementations, to allocate resources, the logic when executed is further operable to perform operations including allocating a higher pixel density to objects that receive an attention value meeting a predetermined attention value criteria such that those objects have a resolution in the one or more photos meeting a predetermined resolution criteria.

### BRIEF DESCRIPTION OF THE DRAWINGS

FIG. 1 illustrates a block diagram of an example network environment, which may be used to implement the implementations described herein.

FIG. 2 illustrates an example simplified flow diagram for optimizing photos in a social network, according to some implementations.

FIG. 3 illustrates an example diagram of an eye tracking device that tracks the gaze of a user, according to some implementations.

FIG. 4 illustrates an example simplified flow diagram for generating an attention map, according to some implementations.

FIG. 5 illustrates an example diagram of an attention map, according to some implementations.

FIG. 6 illustrates an example simplified flow diagram for allocating resources to objects in one or more photos, according to some implementations.

FIG. 7 illustrates a block diagram of an example server device, which may be used to implement the implementations described herein.

### DETAILED DESCRIPTION

Implementations described herein optimize photos. In various implementations, a system collects photos associated with one or more objects, where attention information is captured using a device that is operable to track a gaze of a user. The system then generates an attention map based on the attention information. In some implementations, the attention map is also based on tracking the gaze of a user. For example, in some implementations, the generating may include receiving gaze information; identifying the one or more objects; associating the gaze information with each of the one or more objects; and determining an attention value for each of the one or more objects based on the gaze information.

The system then allocates resources to the one or more objects in one or more photos based on the attention map. In some implementations, the resources include pixels allocated to each of the one or more objects in the photos. In some implementations, the allocating includes allocating a predetermined pixel density to the one or more objects in the photos based on the attention map. For example, in some implementations, the allocating may include allocating a higher pixel density to objects that receive an attention value meeting a first predetermined attention value criteria such that those objects in the photos have a resolution meeting a predetermined resolution criteria. In some implementations, the allocating may include allocating a lower pixel density to objects that receive an attention value meeting a second predetermined attention value criteria.

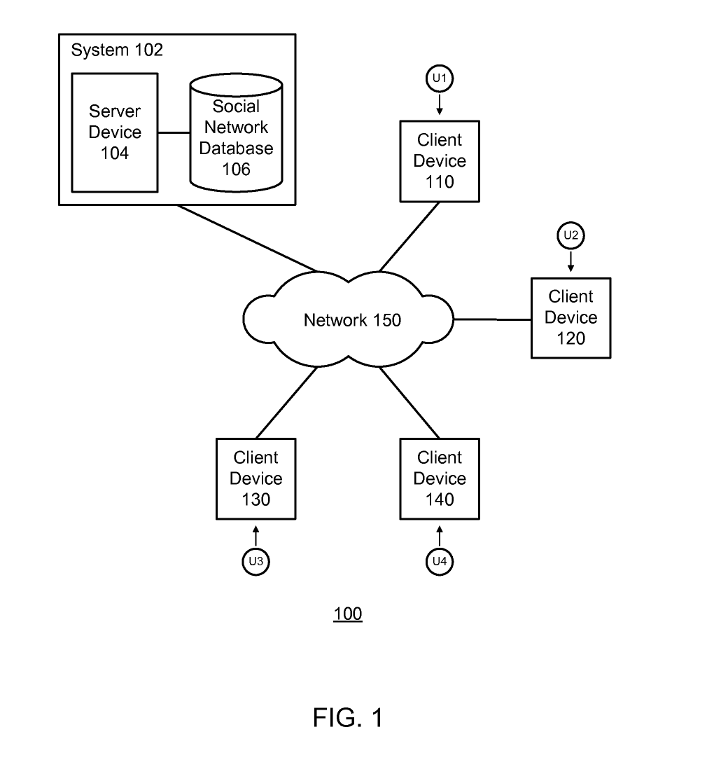

FIG. 1 illustrates a block diagram of an example network environment 100, which may be used to implement the implementations described herein. In some implementations, network environment 100 includes a system 102, which includes a server device 104 and a social network database 106. The term system 102 and phrase “social network system” may be used interchangeably. Network environment 100 also includes client devices 110, 120, 130, and 140, which may communicate with each other via system 102 and a network 150.

For ease of illustration, FIG. 1 shows one block for each of system 102, server device 104, and social network database 106, and shows four blocks for client devices 110, 120, 130, and 140. Blocks 102, 104, and 106 may represent multiple systems, server devices, and social network databases. Also, there may be any number of client devices. In other implementations, network environment 100 may not have all of the components shown and/or may have other elements including other types of elements instead of, or in addition to, those shown herein.

In various implementations, users U1, U2, U3, and U4 may communicate with each other using respective client devices 110, 120, 130, and 140. Users U1, U2, U3, and U4 may also use respective client devices 110, 120, 130, and 140 to take photos. In various implementations, client devices 110, 120, 130, and 140 may include any types of electronic devices such as mobile phones (e.g., smart phones), tablets, notebook computers, desktop computers, digital cameras, etc. Such client devices 110, 120, 130, and 140 that are not dedicated digital cameras may include integrated digital cameras.

In various implementations, system 102 may utilize an eye tracking device for collecting attention information, where the eye tracking device may be used in conjunction with a camera device, which may be a dedicated digital camera or a digital camera integrated with an electronic device (e.g., any of client devices 110, 120, 130, 140, etc.). The eye tracking device may itself be integrated with any one or more of client devices 110, 120, 130, 140, etc. As described in more detail below, such an eye tracking device may be any suitable eye tracking device that measures eye positions such as the point of gaze (e.g., the user's line of sight) and/or measures eye movement.

In some implementations, client devices 110, 120, 130, and 140 may include wearable computing devices, including any hands-free devices. For example, in some implementations, one or more client devices may include devices that operate with a head-mounted camera, head-mounted eye tracking device, and/or head-mounted display.

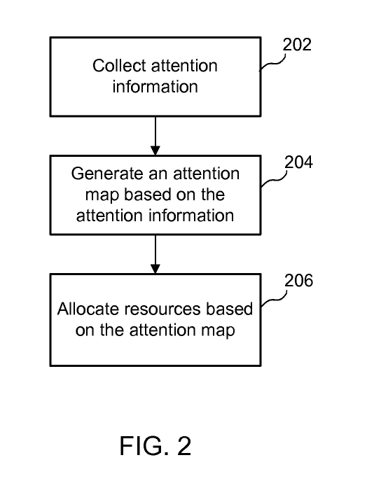

FIG. 2 illustrates an example simplified flow diagram for optimizing photos in a social network, according to some implementations. Referring to both FIGS. 1 and 2, a method is initiated in block 202, where system 102 collects attention information associated with one or more objects. The one or more objects may be set in any given visual context. For example, a given object may be a pyramid in a dessert setting, a statue in a plaza, a particular person's face in a group of people, etc.

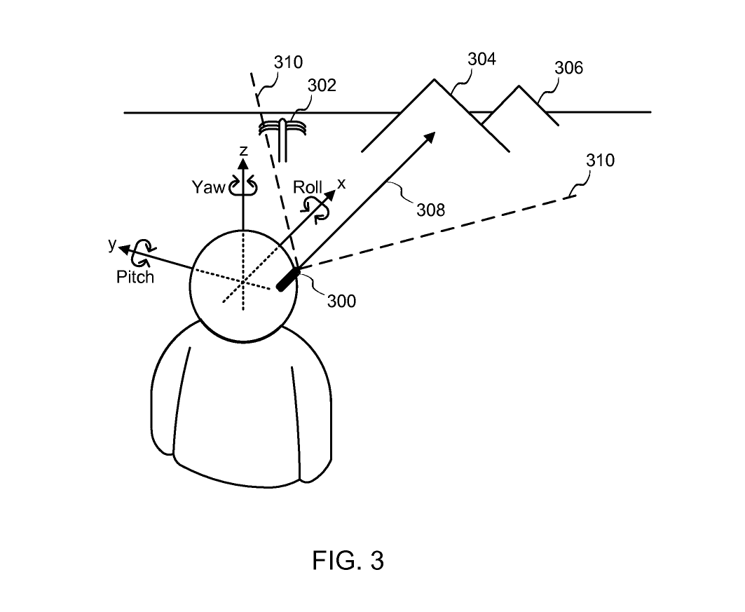

In various implementations, the attention information is captured using an eye tracking device that is operable to track the gaze of a user. Such an eye tracking device may be any suitable eye tracking device that measures the point of gaze (e.g., the user's line of sight). Example implementations of a device that is operable to track the gaze of a user are described in more detail below in connection with FIG. 3.

For ease of illustration, various implementations are described herein in the context of the gaze of a single user. These implementations and others also apply to gazes of multiple users. For example, for a given object (e.g., a well-known monument), system 102 may track, log, and aggregate the gazes of multiple users.

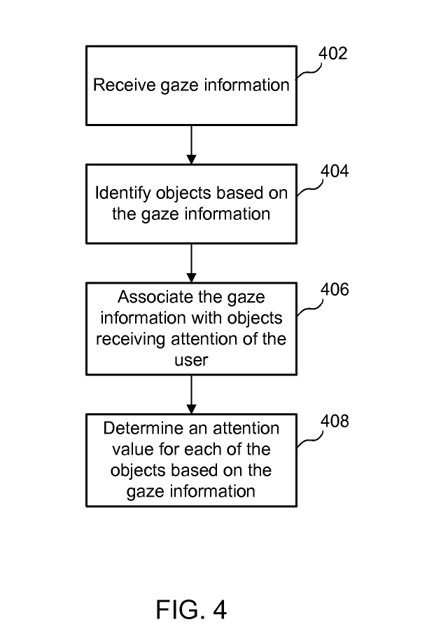

In block 204, system 102 generates an attention map based on the attention information. In some implementations, the attention map may be based at least in part on the tracking of the gaze of a user relative to the one or more objects. Example implementations directed to generating an attention map are described in more detail below in connection with FIG. 4.

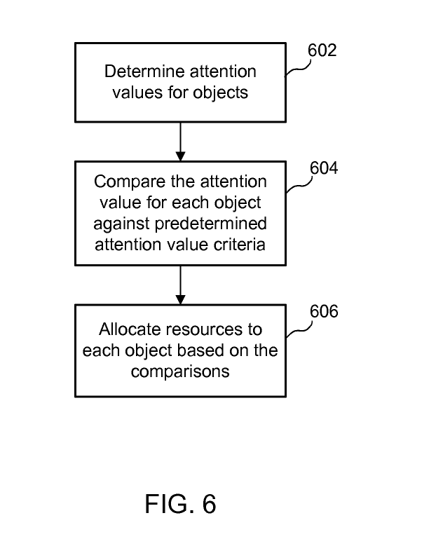

In block 206, system 102 allocates resources to the one or more objects in one or more photos based on the attention map. In some implementations, the resources may include pixels, where system 102 allocates pixels to each of the one or more objects in the photos. As described in more detail below in connection with FIG. 6, system 102 may allocate a predetermined amount of resources (e.g., a predetermined pixel density) to each of the objects in the photos based on the attention map. For example, system 102 may allocate a higher pixel density to objects that receive more attention. Conversely, system 102 may allocate a lower pixel density to objects that receive less attention. As a result, those objects that receive more attention would have a higher resolution in the photos relative to other objects. As a result, in some implementations, system 102 may enable photos to have a foveal-like allocation of resolution such that more resources such as pixels are allocated to portions of the photos where users tend to look.

In some implementations, system 102 provides a selective allocation of resources such as pixels, which optimizes photos for processes such as in image compression processes. Optimizing photos may reduce file sizes of photos during image compression processes, which in turn results in efficient transmission and storage of photos. For example, a main focal point in a given picture (higher attention) would have low compression (higher quality/resolution) during image compression, whereas other areas of the photo may have higher compression (lower quality/resolution) during image compression in order to reduce the file size of the photo. System 102 optimizes photos based on semantic importance based on the attention that one or more users place on objects in the photos. Implementations allocate resources (e.g., pixels, bits, etc.) where they matter most to the user. In other words, system 102 allocates more resources in order to enable a user to capture high-attention objects in photos with higher fidelity than lower attention objects in photos. In some implementations, system 102 determines optimized compression ratios for photos based in attention maps.

FIG. 3 illustrates an example diagram of an eye tracking device 300 that tracks the gaze of a user, according to some implementations. In some implementations, eye tracking device 300 may be positioned in the head area of the user. For example, as shown, eye tracking device 300 may be positioned relatively close to an eye of the user.

In various implementations, eye tracking device 300 may use suitable eye tracking technologies, including any suitable eye-tracking hardware components and algorithms, to measure eye positions and eye movement. For example, eye tracking device 300 may use any suitable eye tracking technologies to measure the gaze of the user (e.g., the user's line of sight) or the motion of an eye relative to the head. For example, eye tracking device 300 may use a laser and laser technology to measure eye positions and eye movement relative to objects in the environment.

In some implementations, eye tracking device 300 may track the gaze of the user by tracking one or more parameters such as pitch, yaw, roll, line of sight, field of view, etc. FIG. 3 shows a pitch axis, yaw axis, and roll axis to illustrate how eye tracking device 300 may move depending on eye movement and/or head movement of the user, as the attention that the user places on particular objects would influence and correlate to both eye movement and head movement of the user.

FIG. 3 shows example objects 302, 304, and 306, where object 302 is a tree, object 304 is a large pyramid, and object 306 is a small pyramid. As shown, objects 302, 304, and 306 are in user's line of site 308 and in the user's field of view 310. For ease of illustration, FIG. 3 shows three objects 302, 304, and 306. Any given scene in the user's field of view 310 may include any number of objects, including people.

In some implementations, system 102 may receive gaze information (e.g., parameter values associated with tracked parameters) directly from eye tracking device 300 or from any other one or more suitable storage locations. For example, in some implementations, eye tracking device 300 may send gaze information to system 102 as the user gazes at particular objects. In some implementations, when used with a camera device, eye tracking device 300 may send gaze information to system 102 as a camera device sends photos to system 102 (e.g., as the photos are captured). In some implementations, eye tracking device 300 may store gaze information local to the user's client device (e.g., if used with a dedicated digital camera, or if used with a mobile phone or other electronic device that has an integrated digital camera, etc.).

FIG. 4 illustrates an example simplified flow diagram for generating an attention map, according to some implementations. Referring to FIGS. 1, 3, and 4, a method is initiated in block 402, where system 102 receives gaze information. In some implementations, the gaze information associated with a given user may also be referred to as the gaze pattern of the user, or the gaze of the user. As indicated above, the gaze information may include one or more parameter values associated with parameters such as pitch, yaw, roll, line of sight, field of view, etc. In some implementations, system 102 may receive gaze information independently of photos being captured. In some implementations, system 102 may also identify a given object based on the gaze information even before the user captures a photo of the object or even if the user does not ultimately capture a photo of the object. Accordingly, system 102 may capture gaze information even if the user is not concurrently capturing photos.

In block 404, system 102 identifies objects based on the gaze information. In some implementations, system 102 may receive one or more photos of one or more objects. System 102 may then identify objects in each photo via any suitable object identification algorithm.

In some implementations, system 102 may also recognize the identified objects. For example, after system 102 identifies an object such as a monument or face, system 102 may then apply a suitable recognition algorithm to recognize an identity associated with the particular object (e.g., monument or particular person). Example implementations directed to object recognition are described in more detail below.

In block 406, system 102 associates the gaze information with each of the one or more objects receiving the attention of the user. For example, in some implementations, the gaze information (e.g., the combination of parameter values) characterizes the gaze of the user. System 102 may determine, from the gaze information, fixation points on one or more objects in a given photo, including fixation points at particular portions of such objects.

Note that a photo need not necessarily be provided by the user associated with the gaze information. System 102 may determine an appropriate photo based on geolocation information, other photos provided by the user associated with the gaze information, etc. In an example implementation, where system 102 aggregates gazes from multiple users, system 102 may associate the gaze information from the different users with the same one or more objects. For example, referring to FIG. 3, if multiple users gaze at object 304, system may associate the gaze information associated with all of such users with the same object 304.

In block 408, system 102 determines an attention value for each of the one or more objects based on the gaze information. In some implementations, the attention value may be based on one or more attention parameters. Such attention parameters may include, for example, the amount of time a given user gazed at a given object. In some implementations, such attention parameters have corresponding attention subvalues that system 102 may aggregate in order to derive a given attention value.

In some implementations, system 102 may assign an attention subvalue that is proportional to the total amount of time that the user gazed at the object. For example, system 102 may assign a higher attention subvalue if the user gazed at the object for 10 minutes versus only 2 minutes.

In some implementations, system 102 may assign an attention subvalue that is proportional to the total number of times that the user gazed at a given object. For example, system 102 may assign a higher attention subvalue if the user gazed at the object 5 different times versus a single time.

In some implementations, system 102 may assign an attention subvalue that is proportional to the total size and/or percentage of a given object at which the user gazed. For example, system 102 may assign a higher attention subvalue if the user gazed at 75% of the object versus 25% of the object.

In some implementations, system 102 may assign an attention subvalue that is proportional to the total number of people who gazed at a given object. For example, system 102 may assign a higher attention subvalue if 1,000 people gazed at the object versus 5 people. Other attention parameters are possible and the particular number of attention parameters and the types of parameters will depend on the particular implementation.

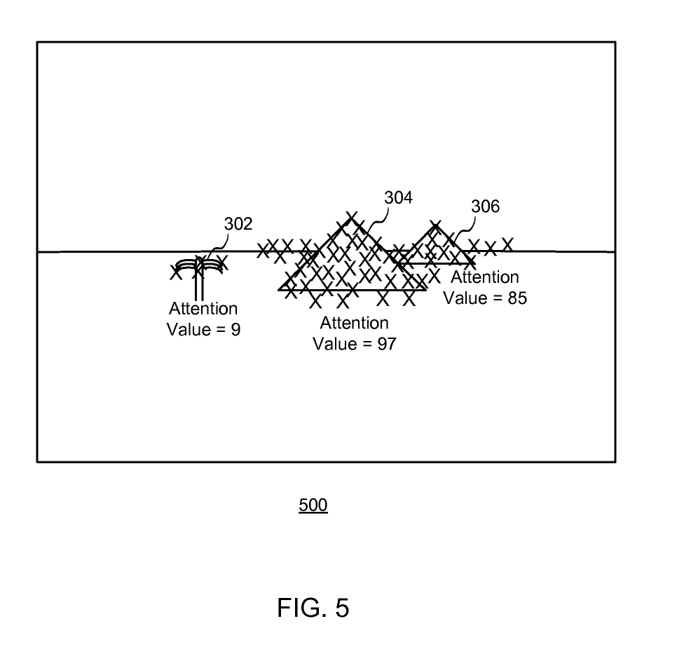

FIG. 5 illustrates an example diagram of an attention map 500, according to some implementations. As shown, objects 302, 304, and 306 are shown with Xs overlaid, where the number of Xs is proportional to the attention value. In some implementations, objects 302, 304, and 306 may each be shown with an actual attention value. For example, as shown in this example implementation, object 302 has an attention value of 9, object 304 has an attention value of 97, and object 306 has an attention value of 85. The range of attention values may vary (e.g., 0 to 1.0; 0 to 100; 1 to 1,000, etc.), and the particular range and/or numbering scheme will depend on the particular implementation.

In some implementations, system 102 may assign a color to each object, where the particular color may correspond to the size of the attention value. For example, an object associated with yellow may have a relatively higher attention value than an object associated with blue; an object associated with orange may have a relatively higher attention value than an object associated with yellow; an object associated with red may have a relatively higher attention value than an object associated with orange. The particular color scheme will vary, depending on the particular implementation.

FIG. 6 illustrates an example simplified flow diagram for allocating resources to objects in one or more photos, according to some implementations. A method is initiated in block 602, where system 102 determines an attention value for each of the one or more objects. In block 604, system 102 compares the attention value for each object against one or more predetermined attention value criteria. In some implementations, the predetermined attention value criteria may include one or more attention thresholds. For example, in some implementations, system 102 may associate a relatively lower attention threshold with a relatively lower pixel density. In some implementations, system 102 may assign a relatively higher attention threshold corresponding to a relatively higher pixel density. The number of attention value thresholds and the actual thresholds may vary, and will depend on the particular implementation.

In block 606, system 102 allocates resources to each object based on the comparisons. For example, in some implementations, system 102 may allocate a higher predetermined pixel density to objects that receive an attention value meeting a first predetermined attention value criteria. As such, system 102 allocates more resources in order to achieve a higher resolution to objects that receive more attention. In some implementations, system 102 may allocate a lower pixel density to objects that receive an attention value meeting a second predetermined attention value criteria. As such, system 102 allocates fewer resources in order to allow a lower resolution to objects that receive less attention.

In some implementations, system 102 may perform anticipatory analytics based on the attention map. For example, a camera device may be location aware, and, based on the location, may determine that the user is likely to capture a photo (e.g., capture a photo of well-known monument from a certain distance). In some implementations, system 102 may then optimize new photos captured as they are captured based on the attention map. In some implementations, system 102 may optimize photos captured some time after they are stored based on the attention map. Such actions may facilitate system 102 in efficiently processing (e.g., transmitting, storing, etc.) photos. As a result, cameras would spend an appropriate amount of resources capturing portions of the environment that warrant it, based on attention.

Although the steps, operations, or computations described herein may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

While system 102 is described as performing the steps as described in the implementations herein, any suitable component or combination of components of system 102 or any suitable processor or processors associated with system 102 may perform the steps described.

In various implementations, system 102 may utilize a variety of recognition algorithms to recognize faces, landmarks, objects, etc. in photos. Such recognition algorithms may be integral to system 102. System 102 may also access recognition algorithms provided by software that is external to system 102 and that system 102 accesses.

In various implementations, system 102 enables users of the social network system to specify and/or consent to the use of personal information, which may include system 102 using their faces in photos or using their identity information in recognizing people identified in photos. For example, system 102 may provide users with multiple selections directed to specifying and/or consenting to the use of personal information. For example, selections with regard to specifying and/or consenting may be associated with individual photos, all photos, individual photo albums, all photo albums, etc. The selections may be implemented in a variety of ways. For example, system 102 may cause buttons or check boxes to be displayed next to various selections. In some implementations, system 102 enables users of the social network to specify and/or consent to the use of using their photos for facial recognition in general. Example implementations for recognizing faces and other objects are described in more detail below.

In various implementations, system 102 obtains reference images of users of the social network system, where each reference image includes an image of a face that is associated with a known user. The user is known, in that system 102 has the user's identity information such as the user's name and other profile information. In some implementations, a reference image may be, for example, a profile image that the user has uploaded. In some implementations, a reference image may be based on a composite of a group of reference images.

In some implementations, to recognize a face in a photo, system 102 may compare the face (i.e., image of the face) and match the face to reference images of users of the social network system. Note that the term “face” and the phrase “image of the face” are used interchangeably. For ease of illustration, the recognition of one face is described in some of the example implementations described herein. These implementations may also apply to each face of multiple faces to be recognized.

In some implementations, system 102 may search reference images in order to identify any one or more reference images that are similar to the face in the photo. In some implementations, for a given reference image, system 102 may extract features from the image of the face in a photo for analysis, and then compare those features to those of one or more reference images. For example, system 102 may analyze the relative position, size, and/or shape of facial features such as eyes, nose, cheekbones, mouth, jaw, etc. In some implementations, system 102 may use data gathered from the analysis to match the face in the photo to one more reference images with matching or similar features. In some implementations, system 102 may normalize multiple reference images, and compress face data from those images into a composite representation having information (e.g., facial feature data), and then compare the face in the photo to the composite representation for facial recognition.

In some scenarios, the face in the photo may be similar to multiple reference images associated with the same user. As such, there would be a high probability that the person associated with the face in the photo is the same person associated with the reference images.

In some scenarios, the face in the photo may be similar to multiple reference images associated with different users. As such, there would be a moderately high yet decreased probability that the person in the photo matches any given person associated with the reference images. To handle such a situation, system 102 may use various types of facial recognition algorithms to narrow the possibilities, ideally down to one best candidate.

For example, in some implementations, to facilitate in facial recognition, system 102 may use geometric facial recognition algorithms, which are based on feature discrimination. System 102 may also use photometric algorithms, which are based on a statistical approach that distills a facial feature into values for comparison. A combination of the geometric and photometric approaches could also be used when comparing the face in the photo to one or more references.

Other facial recognition algorithms may be used. For example, system 102 may use facial recognition algorithms that use one or more of principal component analysis, linear discriminate analysis, elastic bunch graph matching, hidden Markov models, and dynamic link matching. It will be appreciated that system 102 may use other known or later developed facial recognition algorithms, techniques, and/or systems.

In some implementations, system 102 may generate an output indicating a likelihood (or probability) that the face in the photo matches a given reference image. In some implementations, the output may be represented as a metric (or numerical value) such as a percentage associated with the confidence that the face in the photo matches a given reference image. For example, a value of 1.0 may represent 100% confidence of a match. This could occur, for example, when compared images are identical or nearly identical. The value could be lower, for example 0.5 when there is a 50% chance of a match. Other types of outputs are possible. For example, in some implementations, the output may be a confidence score for matching.

For ease of illustration, some example implementations described herein have been described in the context of a facial recognition algorithm. Other similar recognition algorithms and/or visual search systems may be used to recognize objects such as landmarks, logos, entities, events, etc. in order to implement implementations described herein.

Implementations described herein provide various benefits. For example, implementations described herein efficiently allocate resources in image processing. Implementations also achieve a higher resolution for objects in photos that receive more attention. Implementations also allow for lower resolution for objects that receive less attention in photos.

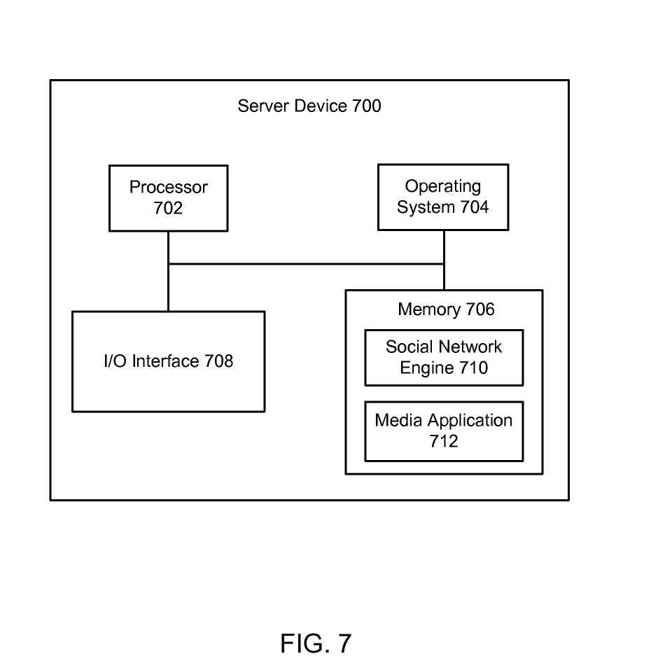

FIG. 7 illustrates a block diagram of an example server device 700, which may be used to implement the implementations described herein. For example, server device 700 may be used to implement server device 104 of FIG. 1, as well as to perform the method implementations described herein. In some implementations, server device 700 includes a processor 702, an operating system 704, a memory 706, and an input/output (I/O) interface 708. Server device 700 also includes a social network engine 710 and a media application 712, which may be stored in memory 706 or on any other suitable storage location or computer-readable medium. Media application 712 provides instructions that enable processor 702 to perform the functions described herein and other functions.

For ease of illustration, FIG. 7 shows one block for each of processor 702, operating system 704, memory 706, I/O interface 708, social network engine 710, and media application 712. These blocks 702, 704, 706, 708, 710, and 712 may represent multiple processors, operating systems, memories, I/O interfaces, social network engines, and media applications. In other implementations, server device 700 may not have all of the components shown and/or may have other elements including other types of elements instead of, or in addition to, those shown herein.

Although the description has been described with respect to particular implementations thereof, these particular implementations are merely illustrative, and not restrictive. Concepts illustrated in the examples may be applied to other examples and implementations.

Note that the functional blocks, methods, devices, and systems described in the present disclosure may be integrated or divided into different combinations of systems, devices, and functional blocks as would be known to those skilled in the art.

Any suitable programming languages and programming techniques may be used to implement the routines of particular implementations. Different programming techniques may be employed such as procedural or object-oriented. The routines may execute on a single processing device or multiple processors. Although the steps, operations, or computations may be presented in a specific order, the order may be changed in different particular implementations. In some particular implementations, multiple steps shown as sequential in this specification may be performed at the same time.

A “processor” includes any suitable hardware and/or software system, mechanism or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

What is claimed is:

1. A method comprising:
collecting attention information associated with one or more objects, wherein the attention information is captured using a device that is operable to track a gaze of a user;
generating an attention map based on the attention information, wherein the generating comprises:
receiving gaze information;
identifying the one or more objects;
associating the gaze information with each of the one or more objects; and
determining an attention value for each of the one or more objects based on the gaze information;
allocating resources to the one or more objects in one or more photos based on the attention map, wherein the resources comprise pixels allocated to each of the one or more objects in the photos, and wherein the allocating comprises:
allocating a higher pixel density to objects that receive an attention value meeting a first predetermined attention value criteria such that those objects have a resolution in the photos meeting a predetermined resolution criteria; and
allocating a lower pixel density to objects that receive an attention value meeting a second predetermined attention value criteria.

2. A method comprising:
collecting attention information associated with one or more objects;
generating an attention map based on the attention information; and
allocating resources to the one or more objects in one or more photos based on the attention map.

3. The method of claim 2, wherein the photos are captured using a device that is operable to track a gaze of a user.

4. The method of claim 2, wherein the attention map is also based on tracking a gaze of a user.

5. The method of claim 2, wherein the generating comprises:
receiving gaze information;
identifying the one or more objects; and
associating the gaze information with each of the one or more objects.

6. The method of claim 2, wherein the generating comprises:
receiving gaze information;
identifying the one or more objects;
associating the gaze information with each of the one or more objects; and
determining an attention value for each of the one or more objects based on the gaze information.

7. The method of claim 2, wherein the resources comprise pixels allocated to each of the one or more objects in the one or more photos.

8. The method of claim 2, wherein the allocating comprises allocating a predetermined pixel density to the one or more objects in the one or more photos based on the attention map.

9. The method of claim 2, wherein the allocating comprises allocating a higher pixel density to objects that receive an attention value meeting a predetermined attention value criteria.

10. The method of claim 2, wherein the allocating comprises allocating a higher pixel density to objects that receive an attention value meeting a predetermined attention value criteria such that those objects have a resolution in the one or more photos meeting a predetermined resolution criteria.

11. The method of claim 2, wherein the allocating comprises allocating a lower pixel density to objects that receive an attention value meeting a predetermined attention value criteria.

12. A system comprising:
one or more processors; and
logic encoded in one or more tangible media for execution by the one or more processors and when executed operable to perform operations comprising:
collecting attention information associated with one or more objects;
generating an attention map based on the attention information; and
allocating resources to the one or more objects in one or more photos based on the attention map.

13. The system of claim 12, wherein the photos are captured using a device that is operable to track a gaze of a user.

14. The system of claim 12, wherein the attention map is also based on tracking a gaze of a user.

15. The system of claim 12, wherein to generate the attention map, the logic when executed is further operable to perform operations comprising:
receiving gaze information;
identifying the one or more objects; and
associating the gaze information with each of the one or more objects.

16. The system of claim 12, wherein to generate the attention map, the logic when executed is further operable to perform operations comprising:
receiving gaze information;
identifying the one or more objects;
associating the gaze information with each of the one or more objects; and
determining an attention value for each of the one or more objects based on the gaze information.

17. The system of claim 12, wherein the resources comprise pixels allocated to each of the one or more objects in the one or more photos.

18. The system of claim 12, wherein to allocate resources, the logic when executed is further operable to perform operations comprising allocating a predetermined pixel density to the one or more objects in the one or more photos based on the attention map.

19. The system of claim 12, wherein to allocate resources, the logic when executed is further operable to perform operations comprising allocating a higher pixel density to objects that receive an attention value meeting a predetermined attention value criteria.

20. The system of claim 12, wherein to allocate resources, the logic when executed is further operable to perform operations comprising allocating a higher pixel density to objects that receive an attention value meeting a predetermined attention value criteria such that those objects have a resolution in the one or more photos meeting a predetermined resolution criteria.
